(19) United States
(12) Patent Application Publication
(10) Pub. No.: US 2026/0219715 A1
(43) Pub. Date: Jul. 30, 2026

(54) SYSTEMS AND METHODS FOR DISABLING POWER SUPPLY UNITS BASED ON USER-SELECTED CRITERIA AND CHARACTERISTICS OF POWER SUPPLY UNITS

(71) Applicant: Lenovo Global Technology (United States) Inc., Morrisville, NC (US)

(72) Inventors: Douglas Evans, Morrisville, NC (US); Brian C. Totten, Morrisville, NC (US); Jose I. Rojas, Morrisville, NC (US); Shawn M. Brown, Morrisville, NC (US)

(21) Appl. No.: 19/037,456

(22) Filed: Jan. 27, 2025

(51) Int. Cl. G06F 1/26; G06F 1/3296

(52) U.S. Cl. CPC G06F 1/263; G06F 1/3296

(57) ABSTRACT

Systems and methods for disabling power supply units based on user-selected criteria and characteristics of power supply units are disclosed. According to an aspect, a computing device including hardware components and power supply units configured to provide power to the hardware components. The computing device also includes a power supply manager configured to receive user selection of one or more criteria to be used in selecting a portion of the plurality of power supply units to disable. Further, the power supply manager receives data indicative of a characteristic of each of the power supply units. The power supply manager selects as the portion of the plurality of power supply units to disable the power supply units of the plurality of power supply units having the characteristic that satisfies the one or more criteria. Further, the power supply manager disables the selected portion of the plurality of power supply units.

### TECHNICAL FIELD

The presently disclosed subject matter relates generally to power supply units of computing devices. Particularly, the presently disclosed subject matter relates to systems and methods for disabling power supply units based on user-selected criteria and characteristics of power supply units.

### BACKGROUND

Servers typically include power supply units (PSUs) that convert input electrical power to one or more different types and/or levels of output power suitable for the server being powered. For example, a power supply unit can receive electrical power from an external source, such as a wall outlet or power main, and convert the received alternating current (AC) power to a low-voltage, regulated direct current (DC) power used by internal hardware components of the server. A power supply unit can provide stable, regulated power to hardware components, such as memory, processors, storage drives, a motherboard, and other components of the server. In many instances, multiple power server units are included and managed in a server for providing features of high efficiency, redundancy, hot-swappable capability, and scalability.

With regard to redundancy, the use of multiple power supply units can provide operability to enable the server to continue to operate via one of the power supply units if another power supply unit fails. A server can operate in a redundant configuration or mode whereby one or more of the power supply units of the server are disabled by switch to a “zero output” state when the system load is low. A redundant mode may be in accordance with either an N+1 model, an N+N model, an N+M model, or other redundancy model. Although use of a redundant mode can help to avoid power supply interruption, there is a need for also improving overall efficiency and reliability.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a system including a server having multiple power distribution units that can be disabled by a power supply manager in accordance with embodiments of the present disclosure;

FIG. 2 is a flow diagram of an example method for disabling power supply units based on user-selected criteria and characteristics of power supply units in accordance with embodiments of the present disclosure;

FIG. 3 is a flow diagram of another example method for disabling power supply units based on user-selected criteria and characteristics of power supply units in accordance with embodiments of the present disclosure;

FIG. 4 is a block diagram and a flow diagram depicting an example method for optimizing efficiency based on vendor; and

FIG. 5 is a block diagram and a flow diagram depicting an example method for optimizing efficiency based on vendor and runtime information.

### SUMMARY

The presently disclosed subject matter relates to systems and methods for disabling power supply units based on user-selected criteria and characteristics of power supply units. According to an aspect, a computing device including hardware components and power supply units configured to provide power to the hardware components. The computing device also includes a power supply manager configured to receive user selection of one or more criteria to be used in selecting a portion of the plurality of power supply units to disable. Further, the power supply manager is configured to receive data indicative of a characteristic of each of the power supply units. The power supply manager is also configured to select as the portion of the plurality of power supply units to disable the power supply units of the plurality of power supply units having the characteristic that satisfies the one or more criteria. Further, the power supply manager is configured to disable the selected portion of the plurality of power supply units. The at least one power supply unit of the plurality of power supply units is not selected and remains enabled.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As referred to herein, the term “computing device” should be broadly construed. For example, a computing device can be a server, a desktop computer, a laptop computer, or the like.

As referred to herein, the term “power supply unit” (or its acronym “PSU”) should be broadly construed as a component that regulates power provided to a computing device. The power supply unit can be an internal hardware component of the computing device and can operate to convert alternating high voltage current (AC) into direct current (DC). Further, the power supply unit can regulate the DC output voltage to tolerances required by components of the computing device. A computing device can include multiple power supply units for redundancy, where in a redundant mode one or more of the power supply units are disabled. The power supply units of a computing device can of the same or of different types (e.g., manufacturer, specification, and model). Power supply units may also have an energy efficiency rating or classification. Example energy efficiency classes of power supply units include, but are not limited to, 80 Plus, 80 Plus Bronze, 80 Plus Silver, 80 Plus Gold, 80 Plus Platinum, and 80 Plus Titanium.

As referred to herein, the term “vital product data” (or its acronym “VPD”) should be broadly construed as information that can identify a hardware and software components of a computing device (e.g., a server). Example vital product data includes, but is not limited to, model number, serial number, installed memory capacity, processor type, firmware versions, and other configuration details. Vital product data can be resident on a component for access by system administrators and service personnel for management and troubleshooting purposes.

As used herein, the term “memory” is generally a storage device of a computing device. Examples include, but are not limited to, read-only memory (ROM) and random access memory (RAM).

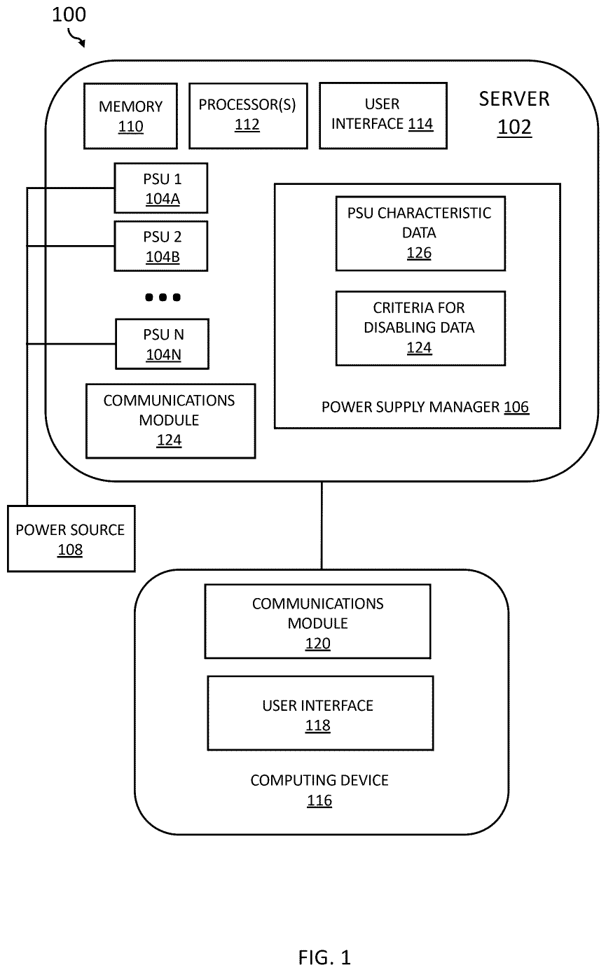

FIG. 1 illustrates a block diagram of a system 100 including a server 102 having multiple power distribution units 1-N 104A-104N that can be disabled by a power supply manager 106 in accordance with embodiments of the present disclosure. Referring to FIG. 1, it should be understood that the server 102 may include any suitable number of power distribution units 104A-104N, and that the letter “N” is representative of the total number of power distribution units residing within the server 102. Power distribution units 104A-104N are operably connected to an external power source 108 (e.g., an electrical outlet). Each power distribution unit 104A-104N may receive power (e.g., AC power) from the power source 108 and convert the received power to DC power for suitably powering memory 110, one or more processors 112, components of a user interface 114, a communications module 116, and the power supply manager 106. The power distribution units 104A-104N may also distribute and regulate power to other hardware components of the server 102.

The power supply manager 106 is described herein as being configured to implement operations for disabling power supply units 104A-104N. For example, the power supply manager 106 can disable one or more of the power supply units 104A-104N based on user-selected criteria and one or more characteristics of the power supply units 104A-104N. The criteria can be selected by the use for optimizing efficiency and/or reliability of operation of the power supply units 104A-104N.

The power supply manager 106 can be implemented by suitable hardware, software, and/or firmware. For example, the power supply manager 106 can be implemented by memory 110 and processor(s) 112 implementing instructions residing on memory 110. In another example, the power supply manager 106 can be implemented by a baseboard management controller (BMC), a power distribution board, or the like.

The power supply manager 106 can receive user selection of one or more criteria for disabling one or more of the power distribution units 104A-104N. In an example, an operator of a computing device 116 can use a user interface 118 of the computing device for entering one or more criteria for disabling one or more of the power distribution units 104A-104N. The computing device 116 can be remote from the server 102, and operable to communicate with the server 102 via a suitable communications network. The computing device 116 can include a communications module 120 that can communicate the user-entered criteria to the server 102. The server 102 can include a communications module 122 for receipt of the user-entered criteria. The power supply manager 106 can receive the user-entered criteria and store user-entered criteria as power supply unit criteria for disabling data 124. The server 102 may require that the data be accepted if it is from an authorized operator at the computing device 116.

In embodiments of a user selecting criteria, the user may select criteria by any suitable manner. For example, a user may select to enter ZOM based on a user-entered preference for efficiency or reliability. The user may select either efficiency or reliability. In another example, a user may select for prioritization of multiple factors. In this example, the user may select an order of preference of factors from most important to least important (e.g, vendor, model, firmware, or Power on Hours).

In another example of entering criteria, an operator of the server 102 can enter one or more criteria for disabling one or more of the power distribution units 104A-104N directly into the server 102. In this instance, the operator can enter the criteria via the user interface 114. Subsequently, the power supply manager 106 can store this entered information as power supply unit criteria for disabling data 124.

The power supply manager 106 can receive data indicative of a characteristic of each of the power supply units 104A-104N. For example, the characteristic data of a power supply manager can be indicative of reliability, efficiency, or the like. As described further herein, this information can be used by the power supply manager 106 for determining whether to disable a power supply unit among multiple power supply units in a server and/or a schedule for disabling power supply units in a server. Example characteristic data can include, but is not limited to, vital product data, data logger, manufacturer identifier, model identifier, a version identifier, power supply unit operational time, power supply unit age, black box data, or the like. The power supply manager 106 can store the characteristic data as power supply unit characteristic data 126.

By use of the criteria for disabling data 124 and the characteristic data 126, the power supply manager 106 can determine which power supply units among the power supply units 104A-104N to disable for optimizing reliability and/or efficiency. The power supply manager 106 can also determine a schedule for disabling the power supply units 104A-104N based on data 124 and 126. For example, the power supply manager 106 can disable one of the power supply units 104A-104N with the other power supply units 104A-104N in a cycle. In a particular example, the power supply unit can be disabled in the cycle for a percentage of time greater than the other power supply units 104A-104N.

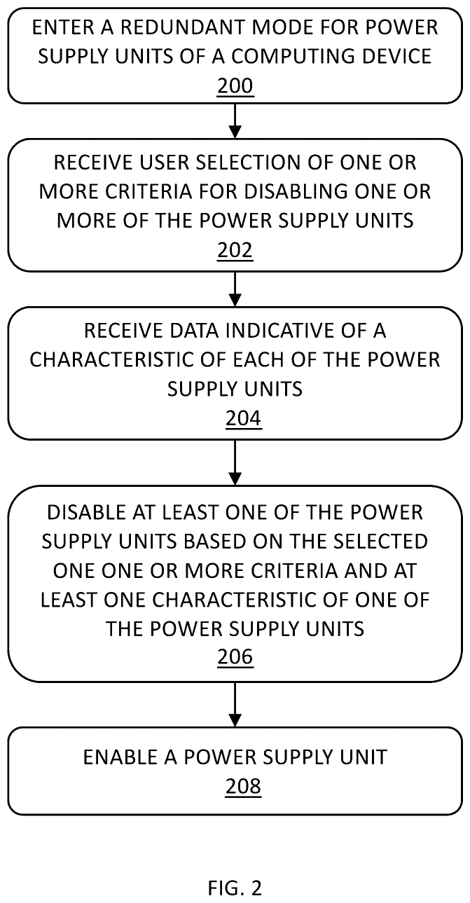

FIG. 2 illustrates a flow diagram of an example method for disabling power supply units based on user-selected criteria and characteristics of power supply units in accordance with embodiments of the present disclosure. It is noted that the method is described by example as being implemented by the system 100 shown in FIG. 1, but it should be appreciated that the method may alternatively be implemented by another system including a server or other computing device having multiple power supply units. In an example, the power supply manager 106 can implement this method in response to determining that the server 102 has entered a zero output mode (ZOM).

Referring to FIG. 2, the method includes entering 200, at a computing device, a redundant mode for power supply units. For example, the server 102 shown in FIG. 1 can enter a redundant mode for its power supply units 104A-104N. The power supply manager 106 may be configured to recognize entry into the redundant mode.

The method of FIG. 2 includes receiving 202 user selection of one or more criteria for disabling one or more of the power supply units. Continuing the aforementioned example, the operator of the computing device 116 can use the user interface 118 for entering one or more criteria for disabling one or more of the power distribution units 104A-104N. Alternatively, for example, the operator of server 102 can enter one or more criteria for disabling one or more of the power distribution units 104A-104N directly into the server 102. The power supply manager 106 can receive the user-entered criteria and store user-entered criteria as power supply unit criteria for disabling data 124.

The method of FIG. 2 includes receiving 204 data indicative of a characteristic of each of the power supply units. Continuing the aforementioned example, the power supply manager 106 can receive one or more data indicative of the characteristics of the power supply units 104A-104N. Example characteristic data can include, but is not limited to, vital product data, data logger, manufacturer identifier, model identifier, a version identifier, power supply unit operational time, power supply unit age, black box data, or the like. The power supply manager 106 can acquire data about a power supply unit by any suitable technique. For example, the power supply manager 106 can collect the data via serial communication bus between the power supply manager 106 and the power supply units. Alternatively, the power supply manager 106 can received input from a user interface or from logic signals.

The method of FIG. 2 includes disabling 206 at least one of the power supply units based on the selected one or more criteria and at least one characteristic of one of the power supply units. Continuing the aforementioned example, the power supply manager 106 can determine which among the power supply units 104A-104N to disable for optimizing reliability and/or efficiency. The power supply manager 106 can also determine a schedule for disabling the power supply units 104A-104N based on data 124 and 126.

The method of FIG. 2 includes enabling 208 a power supply unit. Continuing the aforementioned example, the power supply manager 106 can enable one of the power supply units 104A-104N that was previously disabled. This action may be part of a cycle of rotating power supply operations among the power supply units 104A-104N in the redundant mode. At any particular time, the power supply manager 106 maintains at least one power supply unit 104A-104N as being enabled to assure that server operation is uninterrupted.

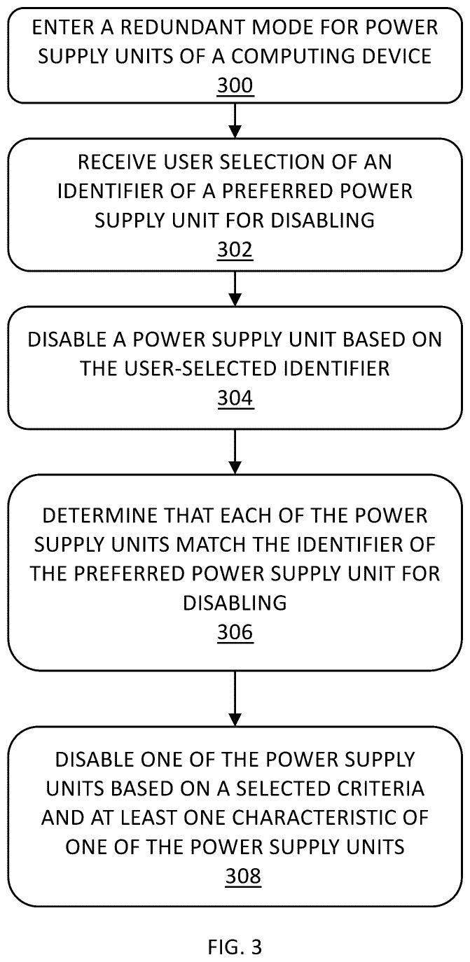

FIG. 3 illustrates a flow diagram of another example method for disabling power supply units based on user-selected criteria and characteristics of power supply units in accordance with embodiments of the present disclosure. It is noted that the method is described by example as being implemented by the system 100 shown in FIG. 1, but it should be appreciated that the method may alternatively be implemented by another system including a server or other computing device having multiple power supply units.

Referring to FIG. 3, the method includes entering 200, at a computing device, a redundant mode for power supply units. For example, the server 102 shown in FIG. 1 can enter a redundant mode for its power supply units 104A-104N. The power supply manager 106 may be configured to recognize entry into the redundant mode.

The method of FIG. 3 includes receiving 302 user selection of an identifier of a preferred power supply unit for disabling. Continuing the aforementioned example, the user selection can include an indication of a preferred vendor or model for disabling. The power supply manager 106 can use this preference as a factor for which power supply unit to disable among the power supply units 104A-104N. In some instances, the user may enter in a model and/or vendor considered to be inefficient or not reliable.

The method of FIG. 3 includes disabling 304 a power supply unit based on the user-selected identifier. Continuing the aforementioned example, the power supply manager 106 can disable one of the power supply units that the model and/or vendor identified by the user.

The method of FIG. 3 can also include determining 306 that each of the power supply units match the identifier of the preferred power supply unit for disabling. In response to determining that each of the power supply units match the identifier, the method can include disabling 308 one of the power supply units based on the selected one or more criteria and at least one characteristic of one of the power supply units. Continuing the aforementioned example, the power supply manager 106 can determine that each of the power supply units 104A-104N match the identifier of the preferred power supply unit for disabling. In response to determining that each of the power supply units 104A-104N match the identifier, the power supply manager 106 can disable one of the power supply units on a selected one or more other criteria entered by the operator and at least one other characteristic of one of the power supply units.

In accordance with some embodiments, criteria can be ranked in order of importance if more than one is selected by an operator. For example, an operator may input multiple criteria for disabling power supply units 104A-104N of the server 102. The power supply manager 106 can subsequently rank the criteria for importance and use in disabling one or more of the power supply units 104A-104N.

In some embodiments, types of criteria may be ranked by a user. For example, a user may want to prioritize disablement of Vendor B's power supply units (rather than Vendor A's power supply units) as a first priority. However, if all power supply units are from the same vendor, a second criterion may be disabling a power supply unit of an older version. However, if all power supply units are the same version, a third criterion may be based on accumulated operational hours. In the case of a basis of operational hours, the power supply unit with a higher number of operational hours can be given priority for disablement. The user can be provided with a menu that allows the user to rank various criteria in a preferred order.

In accordance with some embodiments, an operator may decide to optimize based only on improving efficiency within a computing device with two or more power supply units installed. In an example, the power supply manager 106 may read the vital product data of all installed power supply units 104A-104N. The power supply manager 106 can determine that power supply unit 1 104A is from Vendor A and that power supply unit 2 104B is from Vendor B. In an example, the power supply manager 106 may also determine that any power supply units from Vendor A are 80Plus Titanium, while any power supply units from Vendor B are 80Plus Platinum, which is a lower energy efficiency rating than 80Plus Titanium. Based on the selected criteria of optimizing efficiency, when entering ZOM, the power supply manager 106 can favor the disablement of the power supply unit 104B from Vendor B. The power supply manager 106 can be configured to always disable PSU2 when optimizing efficiency, or if a periodic cycle is chosen, it can assign a larger percentage of off time to the power supply unit 104B from Vendor B.

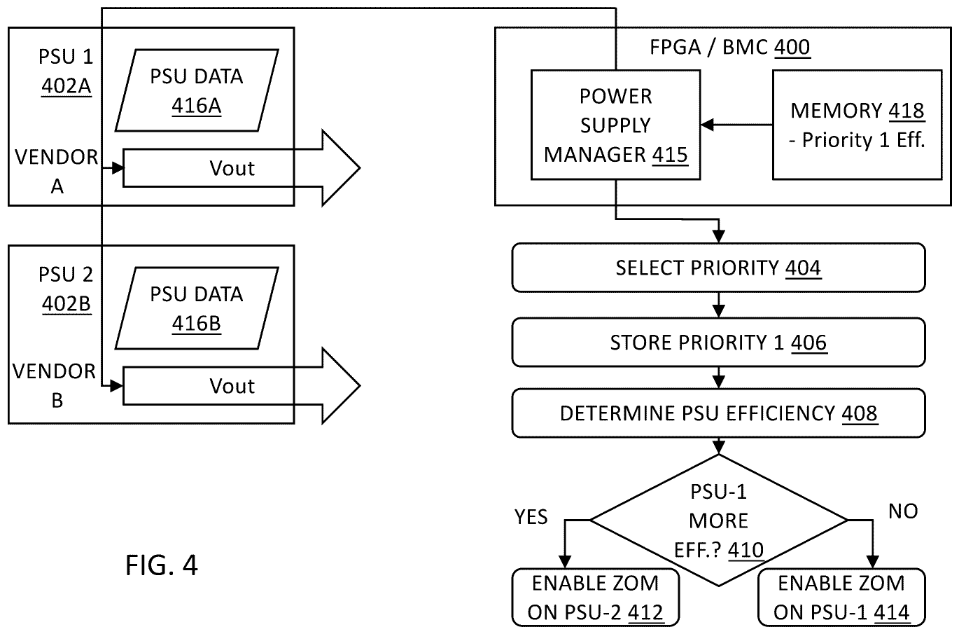

FIG. 4 illustrates a block diagram and a flow diagram depicting an example method for optimizing efficiency based on vendor. Referring to FIG. 4, the block diagram portion shows an FPGA/BMC 400, power supply unit 1 402A, and power supply unit 2 402B. These components can be internal hardware of a computing device, such as a server. The other components of the computing device are not shown for simplification of illustration. The FPGA/BMC 400 can be the components implementing functionalities of a power supply manager as described herein. The flow diagram of FIG. 4 can include functional steps 404, 406, 408, 410, 412, and 414 implemented by the FPGA/BMC 400 as a power supply manager 415. The power supply manager 415 can individually control power supply Vₒᵤₜ of power supply units 402A and 402B.

With continuing reference to FIG. 4, power supply units 402A and 402B can store data 416A and 416B, respectively, that each includes, but is not limited to, vital product data, data log, etc. The FPGA/BMC 400 can include memory 418 that is accessible by the power supply manager 415. The memory 418 can store priority information.

Now turning to the flow diagram of FIG. 4, at step 404 priority is selected. For example, an operator can use a suitable user interface to enter selection of priority, such as an indication that efficiency is the priority. The power supply manager 415 can subsequently store (step 406) the priority information in memory 418.

At step 408, the power supply manager 415 can determine efficiency of the power supply units 402A and 402B. In this example, the power supply manager 415 can retrieve vital product data from each of the power supply units 402A and 402B. The vital product data can identify a vendor or model of the power supply units 402A and 402B. At step 410, the power supply manager 415 can determine which power supply unit 402A or power supply unit 402B is more efficient based on the identified vendor or model. In response to determining that power supply unit 402A is more efficient than power supply unit 402B, the power supply manager 415 can enable zero output mode on power supply unit 402B. Alternatively, in response to determining that power supply unit 402A is not more efficient than power supply unit 402B, the power supply manager 415 can enable zero output mode on power supply unit 402A. As a result, either of the power supply units 402A or 402B can be disabled based on a comparison of their efficiencies.

In accordance with some embodiments, a power supply manager may disable a power supply unit based on firmware version. For example, a power supply manager may read vital product data of all installed power supply units. The power supply manager may determine, based on the vital product data, that 2 power supply units (e.g., power supply unit 1 (PSU1) and power supply unit 2 (PSU2)) are from the same vendor, but one power supply unit PSU1 is using a newer firmware revision as compared to the second power supply unit PSU2. It may be assumed or determined that the newer firmware in power supply unit PSU1 contains efficiency improvements as compared to the original or previous version of firmware. Once this information can be added to memory, the power supply manager can subsequently favor the disablement of power supply unit PSU2 when entering zero output mode (ZOM).

In accordance with some embodiments, a power supply manager can utilize both efficiency and power supply unit runtime information for determining which power supply unit to disable. A goal for this operation can be to increase both system efficiency and reliability. In this example, the power supply manager can disable the power supply unit among the power supply units of a computing device that is determined to have the lowest efficiency and the longest amount of runtime. In an example, this can assume 4 power supply units are installed in a N+1 configuration.

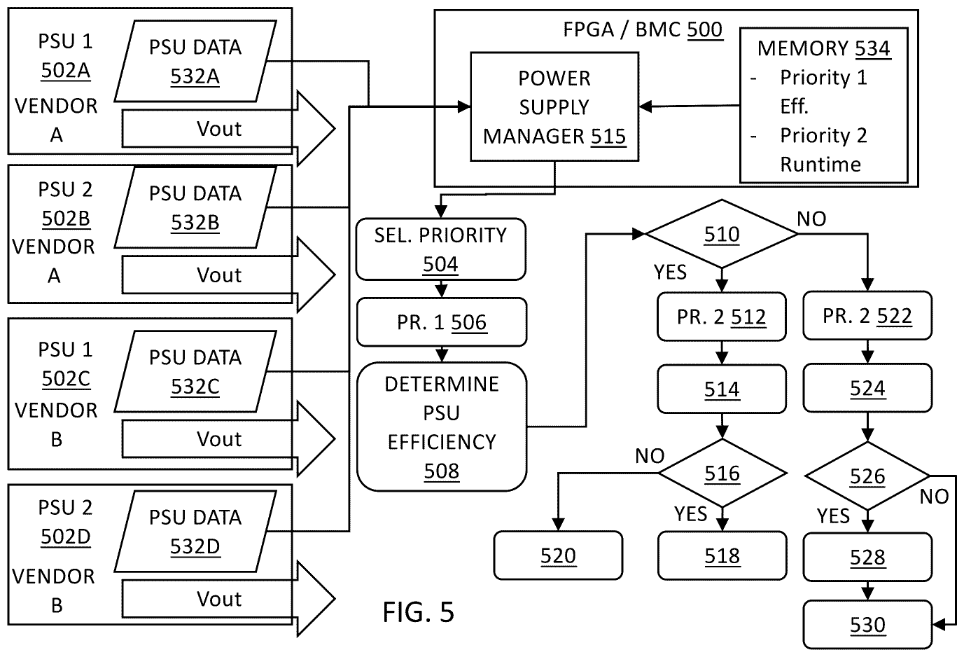

In accordance with embodiments, a power supply manager can optimize efficiency based on vendor and runtime. In this example, the power supply manager of a server can read the vital product data of all installed power supply units of the server. Further, in this example, there are 4 power supply units (although there may be any suitable number of power supply units) with labels PSU1, PSU2, PSU3, and PSU4. In this example, power supply unit PSU1 and PSU2 are from Vendor A, which is 80Plus Titanium, and power supply units PSU3 and PSU4 are from Vendor B, which is 80Plus Platinum. Based on the available information, the power supply manager can select between power supply unit PSU3 and power supply unit PSU4 to optimize efficiency but can also consider the efficiency of power supply unit PSU3 and power supply unit PSU4 to be equivalent. The server can also read the information stored in the datalogger of power supply unit PSU3 and power supply unit PSU4 to determine which one has been operating longer. The server can favor disabling the one with the longest runtime. FIG. 5 provides an example implementation.

Referring to FIG. 5, this figure illustrates a block diagram and a flow diagram depicting an example method for optimizing efficiency based on vendor and runtime information. Referring to FIG. 5, the block diagram portion shows an FPGA/BMC 500, power supply unit 1 502A, power supply unit 2 502B, power supply unit 3 502C, and power supply unit 4 502D. These components can be internal hardware of a computing device, such as a server. The other components of the computing device are not shown for simplification of illustration. The FPGA/BMC 500 can be the components implementing functionalities of a power supply manager as described herein. The flow diagram of FIG. 5 can include functional steps 504, 506, 508, 510, 512, 514, 516, 518, 520, 522, 524, 526, 528, and 530 implemented by the FPGA/BMC 500 as a power supply manager 515. The power supply manager 515 can individually control power supply Vₒᵤₜ of power supply units 502A, 502B, 502C, and 502D.

With continuing reference to FIG. 5, power supply units 502A, 502B, 502C, and 502D can store data 532A, 532B, 532C, and 532D, respectively, that each includes, but is not limited to, vital product data, data log, etc. The FPGA/BMC 500 can include memory 534 accessible by the power supply manager 415. The memory 534 can store priority information, including efficiency and runtime priority information.

Now turning to the flow diagram of FIG. 5, at step 504 priority is selected. For example, an operator can use a suitable user interface to enter selection of priority, such as an indication that efficiency is the priority. The power supply manager 515 can subsequently store (step 506) the priority information in memory 534.

At step 508, the power supply manager 415 can determine efficiency of the power supply units 502A, 502B, 502C, and 502D. The vital product data can identify a vendor of the power supply units 502A, 502B, 502C, and 502D. Power supply units 502A and 502B are from Vendor A, and power supply units 502C and 502D are from Vendor B At step 510, the power supply manager 415 can determine which power supply units among power supply unit 502A, power supply unit 502B, power unit 502C, or 502D are more efficient based on the identified vendor. In response to determining that Vendor A provides a more efficient power supply unit, the method can proceed to step 512 (otherwise, the method proceeds to step 522).

At 512, the method implements analysis of a second priority for consideration by the power supply manager 515. In this example, this is subsequent to determining that power supply units 502C and 502D are more efficient due to being provided by Vendor A. At steps 514 and 516, the power supply manager 515 accesses runtime information and determines a runtime for the power supply units determined to be more efficient than others (e.g., power supply units 502A and 502B). In this example, the power supply manager 515 can access the runtime information for power supply units 502A and 502B in memory 534, which may be obtained by data logs of power supply units 502A and 502B. In response to determining that one power supply unit has a higher runtime, then zero output mode is enabled at step 518. In this example, power supply unit 502A has the higher runtime, thus zero output mode can be enabled on power supply unit 502B. Otherwise, in response to determining that the power supply unit does not have a higher runtime, then zero output mode is enabled on the other power supply unit at step 520. In this example, the zero output mode is enabled on power supply unit 502B.

Now turning to step 522, this step initiates analysis and action for the instance in which Vendor A is not more efficient. At steps 522 and 524, the power supply manager 515 accesses runtime information and determines a runtime for the power supply units determined to be more efficient than others (e.g., power supply units 502C and 502D). In this example, the power supply manager 515 can access the runtime information for power supply units 502C and 502D in memory 534, which may be obtained by data logs of power supply units 502C and 502D. In response to determining that one power supply unit has a higher runtime, then zero output mode is enabled at step 528. In this example, power supply unit 502D has the higher runtime, thus zero output mode can be enabled on power supply unit 502D. Otherwise, in response to determining that the power supply unit does not have a higher runtime, then zero output mode is enabled on the other power supply unit at step 530. In this example, the zero output mode is enabled on power supply unit 502C.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini-or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A computing device comprising:
hardware components;
a plurality of power supply units configured to provide power to the hardware components; and
a power supply manager configured to:
receive user selection of one or more criteria to be used in selecting a portion of the plurality of power supply units to disable;
receive data indicative of a characteristic of each of the power supply units;
select as the portion of the plurality of power supply units to disable the power supply units of the plurality of power supply units having the characteristic that satisfies the one or more criteria; and
disable the selected portion of the plurality of power supply units,
wherein at least one power supply unit of the plurality of power supply units is not selected and remains enabled.

2. The computing device of claim 1, wherein the hardware components comprise one or more of a processor, memory, a communication module, and a user interface.

3. The computing device of claim 1, wherein the power supply manager comprises one of a baseboard management controller or a power distribution board.

4. The computing device of claim 1, wherein at least one of the power supply units comprise one of an 80 Plus power supply unit, an 80 Plus Bronze power supply unit, an 80 Plus Silver power supply unit, an 80 Plus Gold power supply unit, an 80 Plus Platinum power supply unit, and an 80 Plus Titanium power supply unit.

5. The computing device of claim 1, wherein the user selection is entered via a user interface.

6. The computing device of claim 1, wherein the received data comprises one of vital product data, data logger, manufacturer identifier, model identifier, a version identifier, power supply unit operational time, power supply unit age, or black box data.

7. The computing device of claim 1, wherein the received user selection indicates a preference to optimize efficiency and/or reliability of operation of the power supply units.

8. The computing device of claim 1, wherein the received user selection indicates a preferred vendor or model for disabling.

9. The computing device of claim 8, wherein the power supply manager is configured to:
determine that each of the power supply units are the preferred vendor or model; and
disable the selected portion of the plurality of power supply units in response to the determination that each of the power supply units are the preferred vendor or model.

10. The computing device of claim 1, wherein the power supply manager is configured to disable the selected portion of the plurality of power supply units to optimize efficiency and/or reliability of operation of the power supply units based on the selected one or more criteria and at least one characteristic of one of the power supply units.

11. The computing device of claim 1, wherein the power supply manager is configured to disable the selected portion of the plurality of power supply units with the other power supply units in a cycle, wherein the selected portion of the plurality of power supply units is disabled in the cycle for a percentage of time greater than the other power supply units.

12. The computing device of claim 1, wherein the power supply manager is configured to:
determine entry into a zero output mode; and
disable one of the power supply units in response to the determination of entry into the zero output mode.

13. The computing device of claim 1, wherein the power supply manager is configured to:
determine versions of the power supply units;
compare versions of the power supply units; and
disable the selected portion of the plurality of power supply units based on the comparison of the version of the power supply units.

14. A method comprising:
providing a plurality of power supply units configured to provide power to hardware components of a computing device;
receiving user selection of one or more criteria to be used in selecting a portion of the plurality of power supply units to disable;
receiving data indicative of a characteristic of each of the power supply units;
selecting as the portion of the plurality of power supply units to disable the power supply units of the plurality of power supply units having the characteristic that satisfies the one or more criteria; and
disabling the selected portion of the plurality of power supply units,
wherein at least one power supply unit of the plurality of power supply units is not selected and remains enabled.

15. The method of claim 14, further comprising receiving the user selection via a user interface.

16. The method of claim 14, wherein the received data comprises one of vital product data, data logger, manufacturer identifier, model identifier, a version identifier, power supply unit operational time, power supply unit age, or black box data.

17. The method of claim 14, wherein the received user selection indicates a preference to optimize efficiency and/or reliability of operation of the power supply units.

18. The method of claim 14, wherein the received user selection indicates a preferred vendor or model for disabling.

19. The method of claim 14, further comprising disabling the selected portion of the plurality of power supply units to optimize efficiency and/or reliability of operation of the power supply units based on the selected one or more criteria and at least one characteristic of one of the power supply units.

20. The method of claim 14, further comprising disabling the selected portion of the plurality of power supply units with the other power supply units in a cycle, wherein the selected portion of the plurality of power supply units is disabled in the cycle for a percentage of time greater than the other power supply units.
